(19) United States
(12) Patent Application Publication
(10) Pub. No.: US 2016/0366170 A1
(43) Pub. Date: Dec. 15, 2016

(54) SYSTEMS AND METHODS OF DETECTING UTILITY GRID INTRUSIONS

(71) Applicant: Utilidata, Inc., Providence, RI (US)

(72) Inventor: David Gordon Bell, Spokane, WA (US)

(21) Appl. No.: 15/018,596

(22) Filed: Feb. 8, 2016

Related U.S. Application Data
(60) Provisional application No. 62/113,726, filed on Feb. 9, 2015.

(51) Int. Cl. H04L 29/06

(52) U.S. Cl. CPC H04L 63/1425; H04L 63/145

(57) ABSTRACT

Systems and methods of detecting an attack in a utility grid are described. An anomaly detector establishes a first metric generated using signals received from at least one of one or more controllers of the utility grid or one or more metering devices of the utility grid. The first metric identifies nominal behavior of control or consumption in the utility grid absent anomalies. The anomaly detector monitors signals received from the controllers or the metering devices. The anomaly detector determines, using the monitored signals, a second metric identifying current behavior of at least one of control or consumption in the utility grid. The anomaly detector compares the first metric with the second metric to detect an anomaly in control or consumption in the utility grid. The anomaly is attributable to an attack on a controller or a metering device. The anomaly detector provides an alert indicating the detected anomaly.

### CROSS-REFERENCES TO RELATED APPLICATIONS

This application claims priority to, and the benefit of, U.S. Provisional Patent Application No. 62/113,726, filed Feb. 9, 2015, which is incorporated herein by reference in its entirety for all purposes.

### FIELD OF THE DISCLOSURE

This disclosure generally relates to systems and methods of detecting utility grid intrusions. In particular, the systems and methods can identify metrics of the utility grid that indicate nominal behavior, and compare these metrics with signals to detect an anomaly.

### BACKGROUND

A utility grid can include an interconnected network for delivering a utility (e.g., electricity, power, energy, water, gas, natural gas, oil, phone, Internet, or communications bandwidth) from a supplier of the utility to a consumer of the utility. Utility grids may include or interact, interface or communicate with one or more devices or assets that facilitate generating the utility, controlling an aspect of the utility grid, delivering the utility from one point to another point in the utility grid, managing the utility grid, monitoring the utility grid, or tracking the consumption of the utility. These devices can include digital computation devices, systems, processors, or other circuitry configured to facilitate an aspect of the utility grid.

Digital devices may be susceptible to malicious viruses, attacks, exploits, or vulnerabilities that can affect their function or performance. For example, a digital asset in an electrical grid may operate in an abnormal manner causing disturbances to energy delivery conditions in the electric grid. These disturbances may result in service interruptions or may even damage an asset or device of the electrical grid. It may be challenging to detect malicious attacks in a utility grid, thus making it challenging to determine the cause of disturbances in the utility grid.

### BRIEF SUMMARY OF THE DISCLOSURE

Systems and methods of the present disclosure are directed to detecting anomalies in utility grids. More specifically, the systems and methods provide an anomaly detector that can detect intrusions in utility networks based on identifying anomalous relationships and interactions between utility control systems and relevant measures of the behavior of distribution grids. The anomaly detector can determine a behavior of the utility grid and detect, based on the determined behavior, whether there is an anomaly in the utility grid. The anomaly detector may further determine the cause of the anomaly based on the determined behavior.

The anomaly detector can utilize one or more techniques to characterize the consumption of electrical energy by connected customers and the effects this consumption has on devices and structures of the utility grid. For example, the anomaly detector can characterize the consumption and the effects of the consumption by modeling such consumption as stochastic processes. The consumption can be characterized as stochastic processes for the purposes of behavioral analysis, process observation and measurement, quantitative forecasting, grid control and optimization of delivery and consumption efficiencies.

The anomaly detector can identify consumption and control behaviors by using estimators derived from signals obtained from grid instrumentation (e.g., grid metering devices) and grid control devices (e.g., voltage controller or tap regulator). The anomaly detector can use properties of such estimators in order to identify nominal behaviors given certain conditions that influence these behaviors. The conditions that may influence these behaviors can include, e.g., season (winter, spring, summer, fall), ambient temperature, or time of day. The anomaly detector can also use properties of these estimators to identify unusual, abnormal, or otherwise unexpected behaviors of the consumption processes.

For example, the properties of grid metering signals observed by digital computation devices of the utility grid is based on the behavior of consumption of electricity or power by consumer sites. The properties of the grid metering signals can be further based on the actions taken by grid control devices in response to the behavior of the consumption. Consumption or consumer behavior can be driven by seasonal variation, actual daily/hourly weather conditions, typical daily activity associated with employment or recreation, social events and holiday activities. In each case, the consequent demand processes impressed upon the electric power grid can cause the grid control devices to respond in predictable ways. However, when grid control devices do not respond to consumption behavior in a predictable or expected manner, the unexpected or deviant response can be anomalous.

The anomaly detector can use estimators derived from grid metering signals obtained from grid instrumentation or grid control devices to identify the action of the controller in the distribution grid as operated by automatic control systems, or interactions between the consumption processes and the grid control devices and systems. Thus, the anomaly detector can identify an anomaly, and further identify an attack on a grid computation devices caused by malicious code introduced into a digital computation device of the grid.

At least one aspect is directed to a method of detecting an attack in a utility grid. The method includes an anomaly detector executing on one or more processors establishing a first metric generated using signals received from at least one of one or more controllers of the utility grid or one or more metering devices of the utility grid. The first metric can identify nominal behavior of at least one of control or consumption in the utility grid absent anomalies. The method includes the anomaly detector monitoring signals received from at least one of the one or more controllers or the one or more metering devices. The method includes the anomaly detector determining, using the monitored signals, a second metric identifying current behavior of at least one of control or consumption in the utility grid. The method includes the anomaly detector comparing the first metric with the second metric to detect an anomaly in at least one of control or consumption in the utility grid. The anomaly can be attributable to an attack on at least one of a controller of the one or more controllers or a metering device of the one or more metering devices. The method includes the anomaly detector providing an alert indicating the detected anomaly.

In some embodiments, the anomaly detector establishes the first metric as a first consumption metric and a first control metric. The anomaly detector can establish the second metric as a second consumption metric and a second control metric. The anomaly detector can compare the first metric with the second metric to detect the anomaly in an interaction between a control process of the one or more controllers and consumption observed via the one or more metering devices.

In some embodiments, the anomaly detector establishes the first metric as a first consumption metric. The anomaly detector can establish the second metric as a second consumption metric. The anomaly detector can compare the first consumption metric with the second consumption metric to detect the anomaly in consumption observed via the one or more metering devices. The anomaly can be attributable to the attack on the metering device of the one or more metering devices. The anomaly detector can provide the alert indicating the detected anomaly and identifying the metering device affected by the attack that causes the anomaly.

In some embodiments, the anomaly detector establishes the first metric as a first control metric. The anomaly detector can establish the second metric as a second control metric. The anomaly detector can compare the first control metric with the second control metric to detect the anomaly in a control process of the one or more controllers. The anomaly is attributable to an attack on the controller of the one or more controllers. The anomaly detector can provide the alert indicating the detected anomaly and identifying the controller affected by the attack that causes the anomaly.

The attack can include at least one of malware installed on the controller or the metering device configured to cause the anomaly, or malware installed on a third party device configured to attack the controller or the metering device via a network to cause the anomaly.

In some embodiments, the anomaly detector can determine the first metric and the second metric based on one or more energy delivery process metrics comprising at least one of primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites. The anomaly detector can establish the first metric and the second metric based on at least one of a covariance of a scalar stochastic time series, correlation of a scalar stochastic time series, entropy of a scalar stochastic time series, or a transfer function of a system representing the utility grid. The anomaly detector can compare the first metric with the second metric to detect the anomaly using at least one of a vector threshold, a linear discriminant technique, or a neural network.

The anomaly detector can provide, via a network, the alert to a supervisory system of the utility grid, the alert configured to cause the supervisory system to adjust an operation parameter of the controller or the metering device.

The anomaly detector can generate the first metric for a geographic area using at least one of temperature information, humidity information, cloud cover information, or seasonal insolation. The anomaly detector can generate the second metric for the same geographic area to detect the anomaly.

At least one aspect is directed to a system to detect an attack in a utility grid. The system can include a metric detector executed by one or more processors, a metric discriminator executed by the one or more processors, and an alert generator executed by the one or more processors. The metric detector can be configured to establish a first metric generated using signals received from at least one of one or more controllers of the utility grid or one or more metering devices of the utility grid. The first metric can identify nominal behavior of at least one of control or consumption in the utility grid absent anomalies. The metric detector can be configured to monitor signals received from at least one of the one or more controllers or the one or more metering devices. The metric detector can be further configured to determine, using the monitored signals, a second metric identifying current behavior of at least one of control or consumption in the utility grid. The metric discriminator can be configured to compare the first metric with the second metric to detect an anomaly. The anomaly can be attributable to an attack on at least one of a controller of the one or more controllers or a metering device of the one or more metering devices. The alert generator can be configured to provide the alert indicating the anomaly.

In some embodiments, the metric detector can be further configured to establish the first metric as a first consumption metric and a first control metric. The metric detector can be further configured to establish the second metric as a second consumption metric and a second control metric. The metric discriminator can be further configured to compare the first metric with the second metric to detect the anomaly in an interaction between a control process of the one or more controllers and consumption observed via the one or more metering devices.

In some embodiments, the metric detector can be further configured to establish the first metric as a first consumption metric. The metric detector can be further configured to establish the second metric as a second consumption metric. The metric discriminator can be further configured to compare the first consumption metric with the second consumption metric to detect the anomaly in consumption observed via the one or more metering devices. The anomaly can be attributable to the attack on the metering device of the one or more metering devices. The alert generator can be further configured to provide the alert indicating the detected anomaly and identifying the metering device affected by the attack that causes the anomaly.

In some embodiments, the metric detector can be further configured to establish the first metric as a first control metric. The metric detector can be further configured to establish the second metric as a second control metric. The metric discriminator can be further configured to compare the first control metric with the second control metric to detect the anomaly in a control process of the one or more controllers, wherein the anomaly is attributable to an attack on the controller of the one or more controllers. The alert generator can be further configured to provide the alert indicating the detected anomaly and identifying the controller affected by the attack that causes the anomaly.

The attack can include at least one of malware installed on the controller or the metering device configured to cause the anomaly. The attack can include malware installed on a third party device configured to attack the controller or the metering device via a network to cause the anomaly.

The metric detector can be further configured to determine the first metric and the second metric based on one or more energy delivery process metrics comprising at least one of primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites. In some embodiments, the metric detector can be further configured to establish the first metric and the second metric based on at least one of a covariance of a scalar stochastic time series, correlation of a scalar stochastic time series, entropy of a scalar stochastic time series, or a transfer function of a system representing the utility grid. In some embodiments, metric discriminator can be further configured to compare the first metric with the second metric to detect the anomaly using at least one of a vector threshold, a linear discriminant technique, or a neural network.

In some embodiments, the alert generator can be further configured to provide, via a network, the alert to a supervisory system of the utility grid. The alert can be configured to cause the supervisory system to adjust an operation parameter of the controller or the metering device.

In some embodiments, the metric detector can be further configured to generate the first metric for a geographic area using at least one of temperature information, humidity information, cloud cover information, or seasonal insolation. The metric detector can be further configured to generate the second metric for the same geographic area to detect the anomaly.

At least one aspect is directed to a method of detecting an attack in a utility grid. The method can include establishing, by an anomaly detector executing on one or more processors, a consumption metric and a control metric. The consumption metric and the control metric can be generated using signals received from one or more controllers of the utility grid and one or more metering devices of the utility grid. The established consumption metric and the control metric can identify nominal behavior of the utility grid. The method can include the anomaly detector monitoring signals received from the one or more controllers and the one or more metering devices. The method can include the anomaly detector comparing the consumption metric and the control metric with a metric generated using monitored signals to detect an anomaly in an interaction between a control process of the one or more controllers and consumption observed via the one or more metering devices. The anomaly can be attributable to an attack on at least one of a controller of the one or more controllers or a metering device of the one or more metering devices. The method can include the anomaly detector providing an alert indicating the detected anomaly.

In some embodiments, the attack includes malware installed on the controller or the metering device configured to cause the anomaly. The attack can include malware installed on a third party device configured to attack the controller or the metering device via a network to cause the anomaly. The third party device can be remote from the controller, metering device, utility grid, or component thereof.

The anomaly detector can determine the consumption metric or the control metric based on energy delivery process metrics. Energy delivery process metric can include at least one of primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites.

The anomaly detector can provide, via a network, the alert to a supervisory system of the utility grid. The alert can be configured to cause the supervisory system to adjust an operation parameter of the controller or the metering device.

Another aspect is directed to a system to detect an attack in a utility grid. The system can include a metric detector, a metric discriminator and an alert generator. The metric detector, metric discriminator and alert generator can execute on one or more processors. The metric detector can establish a consumption metric and a control metric generated using signals received from one or more controllers of the utility grid and one or more metering devices of the utility grid. The consumption metric and the control metric can represent nominal behavior of the utility grid. The metric detector can monitor signals received from the one or more controllers and the one or more metering devices. The metric discriminator can compare the consumption metric and the control metric with a metric generated using the monitored signals to detect an anomaly in an interaction between a control process of the one or more controllers and consumption observed via the one or more metering devices. The anomaly can be attributable to an attack on at least one of a controller of the one or more controllers or a metering device of the one or more metering devices. The alert generator can provide an alert indicating the detected anomaly.

In some embodiments, the attack includes at least one of malware installed on the controller or the metering device configured to cause the anomaly. The attack can include malware installed on a third party device configured to attack the controller or the metering device via a network to cause the anomaly.

The metric detector can determine the consumption metric or the control metric based on energy delivery process metrics. Energy delivery process metric can include at least one of primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites.

The alert generator can provide, via a network, the alert to a supervisory system of the utility grid. The alert generator or alert can cause the supervisory system to adjust an operation parameter of the controller or the metering device.

Another aspect is directed to a method of detecting an attack in a utility grid. The method can include an anomaly detector executing on one or more processors establishing a consumption metric. The anomaly detector can establish or generate the consumption metric using signals received from one or more metering devices of the utility grid. The consumption metric can represent nominal behavior of the utility grid. The method can include the anomaly detector monitoring signals received from the one or more metering devices. The method can include the anomaly detector comparing the consumption metric with a metric generated using the monitored signals to detect an anomaly in consumption observed via the one or more metering devices. The anomaly can be attributable to an attack on a metering device of the one or more metering devices. The method can include the anomaly detector providing an alert indicating the detected anomaly. The anomaly detector can provide an alert that identifies the metering device affected by the attack that causes the anomaly.

Another aspect is directed to a system to detect an attack in a utility grid. The system can include a metric detector, metric discriminator and alert generator executed by one or more processors. The metric detector can identify a consumption metric generated using signals received from one or more metering devices of the utility grid. The consumption metric can indicate nominal behavior of a utility grid. The metric detector can monitor signals received from the one or more metering devices. The metric discriminator can compare the consumption metric with a metric generated using the monitored signals to detect an anomaly in consumption observed via the one or more metering devices. The anomaly can be attributable to an attack on a metering device of the one or more metering devices. The alert generator can provide an alert indicating the detected anomaly and identifying the metering device affected by the attack that causes the anomaly.

Another aspect is directed to method of detecting an attack in a utility grid. The method can include an anomaly detector executing on one or more processors establishing a control metric. The control metric can be generated by the anomaly detector using signals received from one or more controllers of the utility grid. The control metric can indicate nominal behavior of a utility grid. The method can include the anomaly detector monitoring signals received from the one or more controllers. The method can include the anomaly detector comparing the control metric with a metric generated using the monitored signals to detect an anomaly in a control process of the one or more controllers. The anomaly can be attributable to an attack on a controller of the one or more controllers. The method can include the anomaly detector providing an alert that indicates the detected anomaly and identifies the controller affected by the attack that causes the anomaly.

The anomaly detector can generate the control metric for a geographic area using at least one of temperature information, humidity information, cloud cover information, or seasonal insolation. The anomaly detector can monitor the signals for the same geographic area to detect the anomaly.

Another aspect is directed to a system to detect interactions in a utility grid. The system can include a metric detector, metric discriminator, and alert generator executed by one or more processors. The metric detector can establish a control metric generated using signals received from one or more controllers of the utility grid. The control metric can indicate nominal behavior of a utility grid. The metric detector can monitor signals received from the one or more controllers. The metric discriminator can compare the control metric with a metric generated using the monitored signals to detect an anomaly in a control process of the one or more controllers. The anomaly can be attributable to an attack on a controller of the one or more controllers. The alert generator can provide an alert indicating the detected anomaly and identifying the controller affected by the attack that causes the anomaly.

### BRIEF DESCRIPTION OF THE FIGURES

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram depicting an illustrative utility grid in accordance with an embodiment.

FIGS. 2A and 2B are block diagrams depicting embodiments of computing devices useful in connection with the systems and methods described herein.

FIG. 3 is a bock diagram depicting a system for detecting anomalies in a utility grid in accordance with an embodiment.

FIG. 4 is a flow chart depicting a method for detecting anomalies in a utility grid in accordance with an embodiment.

FIG. 5 is a flow chart depicting a method for detecting anomalies in a utility grid in accordance with an embodiment.

Like reference numbers and designations in the various drawings indicate like elements.

### DETAILED DESCRIPTION

Systems and methods of the present disclosure are directed to detecting anomalies in utility grids. Utility grids use digital computation devices and systems to measure, monitor, and control aspects of the utility grid and protect assets of the utility grid. Digital computing devices can include, e.g., grid digital instrumentation such as voltage controllers, regulators, or metering devices. When these digital computation devices are connected to communication networks (e.g., the Internet for the purpose of remote supervision, remote measurement, or remote status reporting), they may be vulnerable to attacks such as cyber-attacks or electronic attacks. An attack can include an intrusion by malicious software code such as viruses or other malware. Even if the system includes digital network protection devices or systems (e.g., firewalls, virus scanning applications, etc.), the system may not detect the presence of the malicious code at all, or for a duration of time. Therefore, the malicious code may execute on the system and cause anomalies such as abnormal asset operations, disturbances to energy delivery conditions in the utility grid, and may even cause service interruptions and asset damage. However, since the system may not identify the anomaly or detect the malicious code, the anomaly or the cause of such anomaly or abnormality may be unknown.

Systems and methods of the present disclosure can detect an attack in a utility grid. For example, the systems and methods can include an anomaly detector that can detect the presence of intrusions in utility networks, either malware operating in one or more of the digital devices in utility networks or an intruder or malicious agent operating on the digital devices in the utility network from outside such network, by identifying anomalous interactions between utility control systems and relevant measures of the behavior of distribution grids. The anomaly detector can determine a behavior of the utility grid and detect, based on the determined behavior, whether there is an anomaly in the utility grid. By detecting the anomaly, the anomaly detector can determine the cause of the anomaly to be malicious code that has infected the system, or a malicious actor externally causing the anomaly via a network.

To detect anomalies in the utility grid, the anomaly detector can employ or utilize behavior detection metrics, obtained from properties of estimators derived from signals obtained from digital grid assets, quantitatively discriminate the behavior detection metrics, and report the identified behavior to a supervisory system. Behavior detection metrics can include, for example, control metrics and consumption metrics. The anomaly detector can analyze, process, determine or identify actions of a control system or energy delivery process metrics (e.g., in utility grid) that are observed either as a sequence of discrete events or as a continuous function of time to determine a control metric or a consumption metric.

The anomaly detector can use one or more detection methods to generate the behavior detection metrics, including the control metric and the consumption metric. The detection methods can include, e.g., generating statistics of a random process, generating one or more information content metrics suitable for random processes, or applying these statistics or information content metrics to process interaction measures.

The anomaly detector can use one or more signals received from digital computation devices to generate the behavior detection metrics. The anomaly detector can determine the behavior detection metrics from properties of estimators derived from signals obtained from the digital computation devices. For example, in the context of an electric distribution grid (e.g., power distribution grid or utility grid), the signal may correspond to a time series measurement taken at a circuit in a distribution grid that is energized by at least one substation. The signals can include one or more of the following: primary voltages, one or more phases, obtained from metering devices; secondary voltages, one or more phases, obtained from an advanced metering infrastructure (AMI) system; real energy and reactive energy as metered on the distribution circuit primary level; power or demand determined as the first time derivative of energy; real energy and reactive energy where applicable on secondary distribution; or temperature, humidity, cloud cover, or seasonal insolation for the affected area. In some cases, signals may include or refer to changes in supplied voltage (e.g., via adjusting tap settings) or changes in consumption.

The anomaly detector can then process or analyze one or more of these signals to produce detection behavior metrics, including control metrics and consumption metrics. The anomaly detector can process the signals using, for example, auto-covariance of scalar stochastic time series (SSTS); covariance of a plurality of SSTS; auto- and cross-correlation of SSTS; entropy of SSTS as estimated from probability densities; models of temporal behavior of signals, such as auto regressive (AR), moving average (MA), combined auto regressive moving average (ARMA), ARMA with assumed exogenous excitation components (ARMAX); models of temporal behavior of signals that contemplate nonlinearity in the processes generating such signals; coupled entropic measures of plural SSTS, such as the Kullback-Leibler Entropy; principal components analysis of hyper-dimensional signals resulting from matrix combinations of a plurality of signals recited above; or components of the Relative Gain Array as estimated for random signals.

For example, the anomaly detector can process the signals using an auto-covariance of the SSTS, which can include a function that provides the covariance of the process with itself at pairs of time points. The metered signals can be modeled as an SSTS if the time series of the signals satisfy the Gaussian processes and Markov processes.

The detection behavior metrics determined by the anomaly can be quantitatively discriminated such that the system can identify deviations from expected process behavior. The anomaly detector can continue to monitor signals received from digital devices, and compare the behavior detection metrics with these monitored signals. The anomaly detector can compare the behavior metrics derived from these monitored signals with the same reference or nominal metrics that do not contain anomalies. For example, the system can be configured to use one or more of the following techniques to quantitatively discriminate the behavior detection metrics: simple vector threshold testing; linear discriminant analysis; or pattern identification and classification (e.g., using neural network methods); or symbolic regression of the expression spaces of the detection metrics; or regression methods applied to the parameters of the behavior detection metrics for identification of the most significant parameters, including methods such as conventional parsimony evaluation of regression coefficients.

Upon identifying the deviations from the expected process behavior or nominal process, the anomaly detector can report the identification of anomalous or otherwise unexpected process or consumption behaviors. The report (or alert) can indicate the anomaly is caused by an attack on a digital computation device of the grid. The report can include measures of confidence of detection and a likelihood of the presence of malware or an external malicious actor. The report can identify the digital computation device affected by the attack. The anomaly detector can provide the report to a supervisory system or an operator of the utility grid. The report may further include search advisory information that can be input into a digital network traffic analysis system. This information can be determined by analyzing the network connectivity of affected assets in the utility grid.

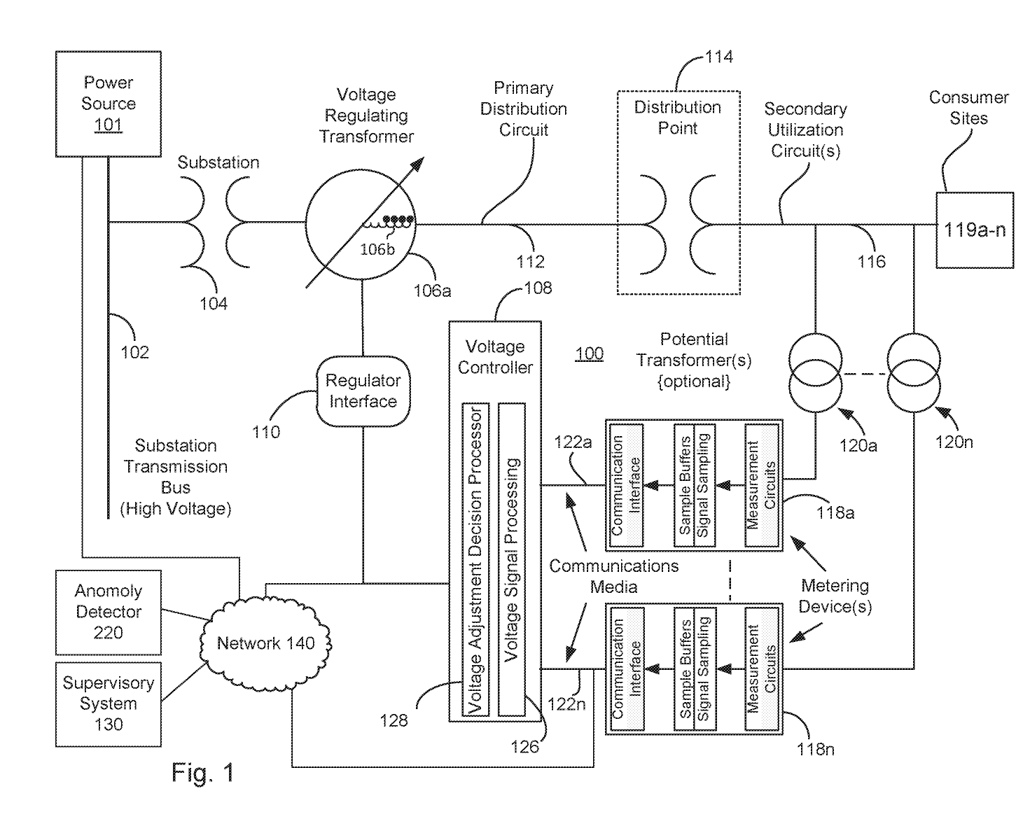

FIG. 1 illustrates a utility grid 100 including an electricity distribution grid with several devices, assets, or digital computational devices and systems, such as computing device 200. In brief overview, the utility grid 100 includes a power source 101 that can be connected via a subsystem transmission bus 102 and/or via substation transformer 104 to a voltage regulating transformer 106a. The voltage regulating transformer 106a can be controlled by voltage controller 108 with regulator interface 110. Voltage regulating transformer 106a may be optionally coupled on primary distribution circuit 112 via optional distribution transformer 114 to secondary utilization circuits 116 and to one or more electrical or electronic devices 119. Voltage regulating transformer 106a can include multiple tap outputs 106b with each tap output 106b supplying electricity with a different voltage level. The utility grid 100 can include monitoring devices 118a-118n that may be coupled through optional potential transformers 120a-120n to secondary utilization circuits 116. The monitoring or metering devices 118a-118n may detect (e.g., continuously, periodically, based on a time interval, responsive to an event or trigger) measurements and continuous voltage signals of electricity supplied to one or more electrical devices 119 connected to circuit 112 or 116 from a power source 101 coupled to bus 102. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

Still referring to FIG. 1, and in further detail, the utility grid 100 includes a power source 101. The power source 101 may include a generating station such as an installation configured to generate electrical power for distribution. The power source 101 may include an engine, a turbine or other apparatus that generates electrical power. The power source 101 may create electrical power by converting power or energy from one state to another state. In some embodiments, the power source 101 may be referred to or include a power plant, power station, generating station, powerhouse or generating plant. In some embodiments, the power source 101 may include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage AC and DC systems, and come in a wide variety of shapes and sizes. In an illustrative example, a transmission tower can range in height from 15 to 55 meters or up to several hundred meters. Transmission towers 102 can be of various types including, e.g., suspension, terminal, tension, and transposition. In some embodiments, the utility grid 100 may include underground power lines in addition to or instead of transmission towers 102.

In some embodiments, the utility gird 100 includes a substation 104 or electrical substation 104 or substation transformer 104. A substation may be part of an electrical generation, transmission, and distribution system. In some embodiments, the substation 104 transform voltage from high to low, or the reverse, or performs any of several other functions to facilitate the distribution of electricity. In some embodiments, the utility grid 100 may include several substations 104 between the power plant 101 and the consumer electoral devices 119 with electric power flowing through them at different voltage levels.

In some embodiments, the substations 104 may be remotely operated, supervised and controlled (e.g., via a supervisory system 130 or supervisory control and data acquisition system 130). A substation may include one or more transformers to change voltage levels between high transmission voltages and lower distribution voltages, or at the interconnection of two different transmission voltages.

The supervisory system 130 can communicate, interact or interface with substations 104 via network 140. In some cases, the supervisory system 130 can be located at or near a substation 104. In some cases, the substation 104 includes the supervisory system 130. The supervisory system 130 can be setup at the substation and connect with one or more components of the substation 104 via a private connection or a direct connection. The supervisory system 130 can be configured to automatically control the substation or one or more component of the utility grid 100.

The supervisory system 130 can be configured to perform data acquisition, supervision or control. The supervisory system 130 can perform data acquisition by acquiring, or collecting, data such as measured analog current or voltage values or the open or closed status of contact points. Acquired data can be used locally within the device collecting it, sent to another device in a substation, or sent from the substation to one or several databases for use by operators, engineers, planners, and administration.

The supervisory system 130 can facilitate supervising the utility grid or the substation via computer processes and providing personnel access to information. The supervisory system 130 can supervise, or monitor, the conditions and status of the utility grid 100 using this acquired data. The supervisory system 130 can display reports or alerts to operators or engineers of the utility grid 100. For example, operators and engineers can monitor the information remotely on computer displays and graphical wall displays or locally, at the device or substation, on front-panel displays and laptop computers.

The supervisory system 130 can control the substation or one or more digital computation device of the utility grid 100 by sending command messages to the digital computation device to operate. In some cases, an operator supervising the system can initiate commands from an operator console. Field personnel can also control digital computation devices using front-panel push buttons or a laptop computer. In some embodiments, the supervisory system 130 can automatically send a command, instruction or message to a digital computation device responsive to an alert or instruction received from the anomaly detector 220. The supervisory system 130 can, responsive to the alert, adjust an operation parameter of the digital computation device. For example, the supervisory system 130 can, responsive to the alert indicating that a digital computation device has been affected by an attack that causes an anomaly, disable the digital computation device, reset the digital computation device, restart the digital computation device, reset the digital computation device to factory settings, or apply a software patch or update to the digital computation device. In some cases, an operator, engineer or other personnel can adjust the operational parameter responsive to the report or alert. The operator, engineer or other personnel can adjust the operation parameter via the supervisory system 130, or may directly adjust the digital computation device via an input/output interface of the digital computation device.

The supervisory system 130 can perform power-system integration by communicating data to, from, or among metering devices, control devices, grid digital instrumentation, or remote users. Substation integration can refer to combining data from metering device local to a substation so that there is a single point of contact in the substation for instrumentation and control.

In some embodiments, the regulating transformer 106 is can include: (1) a multi-tap autotransformer (single or three phase), which are used for distribution; or (2) on-load tap changer (three phase transformer), which can be integrated into a substation transformer 104 and used for both transmission and distribution. The illustrated system described herein may be implemented as either a single-phase or three-phase distribution system. The utility grid 100 may include an alternative current (AC) power distribution system and the term voltage may refer to an “RMS Voltage”, in some embodiments.

In some embodiments, the utility grid 100 includes a distribution point 114 or distribution transformer 114, which may refer to an electric power distribution system. In some embodiments, the distribution point 114 may be a final or near final stage in the delivery of electric power. For example, the distribution point 114 can carry electricity from the transmission system (which may include one or more transmission towers 102) to individual consumers 119. In some embodiments, the distribution system may include the substations 104 and connect to the transmission system to lower the transmission voltage to medium voltage ranging between 2 kV and 69 kV with the use of transformers, for example. Primary distribution lines or circuit 112 carry this medium voltage power to distribution transformers located near the customer's premises 119. Distribution transformers may further lower the voltage to the utilization voltage of appliances and may feed several customers 119 through secondary distribution lines or circuits 116 at this voltage. Commercial and residential customers 119 may be connected to the secondary distribution lines through service drops. In some embodiments, customers demanding high load may be connected directly at the primary distribution level or the sub-transmission level.

In some embodiments, the utility grid 100 includes or couples to one or more consumer sites 119. Consumer sites 119 may include, for example, a building, house, shopping mall, factory, office building, residential building, commercial building, stadium, movie theater, etc. The consumer sites 119 may be configured to receive electricity from the distribution point 114 via a power line (above ground or underground). In some embodiments, a consumer site 119 may be coupled to the distribution point 114 via a power line. In some embodiments, the consumer site 119 may be further coupled to a site meter 118a-n or advanced metering infrastructure (“AMI”).

In some embodiments, the utility grid 100 includes site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter may be referred to as meter observations or metering observations and may include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) may include or be coupled to a corresponding site meter or monitoring device 118a-118n.

Monitoring devices 118a-118n may be coupled through communications media 122a-122n to voltage controller 108. Voltage controller 108 can compute (e.g., continuously or based on a time interval or responsive to a condition/event) values for electricity that facilitates regulating or controlling electricity supplied or provided via the utility grid. For example, the voltage controller 108 may compute estimated deviant voltage levels that the supplied electricity (e.g., supplied from power source 101) will not drop below or exceed as a result of varying electrical consumption by the one or more electrical devices 119. The deviant voltage levels may be computed based on a predetermined confidence level and the detected measurements. Voltage controller 108 can include a voltage signal processing circuit 126 that receives sampled signals from metering devices 118a-118n. Metering devices 118a-118n may process and sample the voltage signals such that the sampled voltage signals are sampled as a time series (e.g., uniform time series free of spectral aliases or non-uniform time series).

Voltage signal processing circuit 126 may receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and may perform the same function. For example, in some embodiments the functionality may be carried out using one or more digital processors, e.g., implementing one or more digital signal processing algorithms. Adjustment decision processor circuit 128 may determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 may also receive information about voltage regulator transformer 106a or output tap settings 106b via the regulator interface 110. Regulator interface 110 may include a processor controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 140 may be any type and/or form of network. The geographical scope of the network 140 may vary widely and the network 140 can be a body area network (BAN), a personal area network (PAN), a local-area network (LAN), e.g. Intranet, a metropolitan area network (MAN), a wide area network (WAN), or the Internet. The topology of the network 140 may be of any form and may include, e.g., any of the following: point-to-point, bus, star, ring, mesh, or tree. The network 140 may be an overlay network which is virtual and sits on top of one or more layers of other networks 104′. The network 140 may be of any such network topology as known to those ordinarily skilled in the art capable of supporting the operations described herein. The network 140 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 140 may be a type of a broadcast network, a telecommunications network, a data communication network, or a computer network.

One or more components, assets, or devices of utility grid 100 may communicate via network 140. The utility grid 100 can one or more networks, such as public or private networks. The utility grid 100 can include an anomaly detector 200 designed and constructed to communicate or interface with utility grid 100 via network 140. Each asset, device, or component of utility grid 100 can include one or more computing devices 200 or a portion of computing 200 or a some or all functionality of computing device 200.

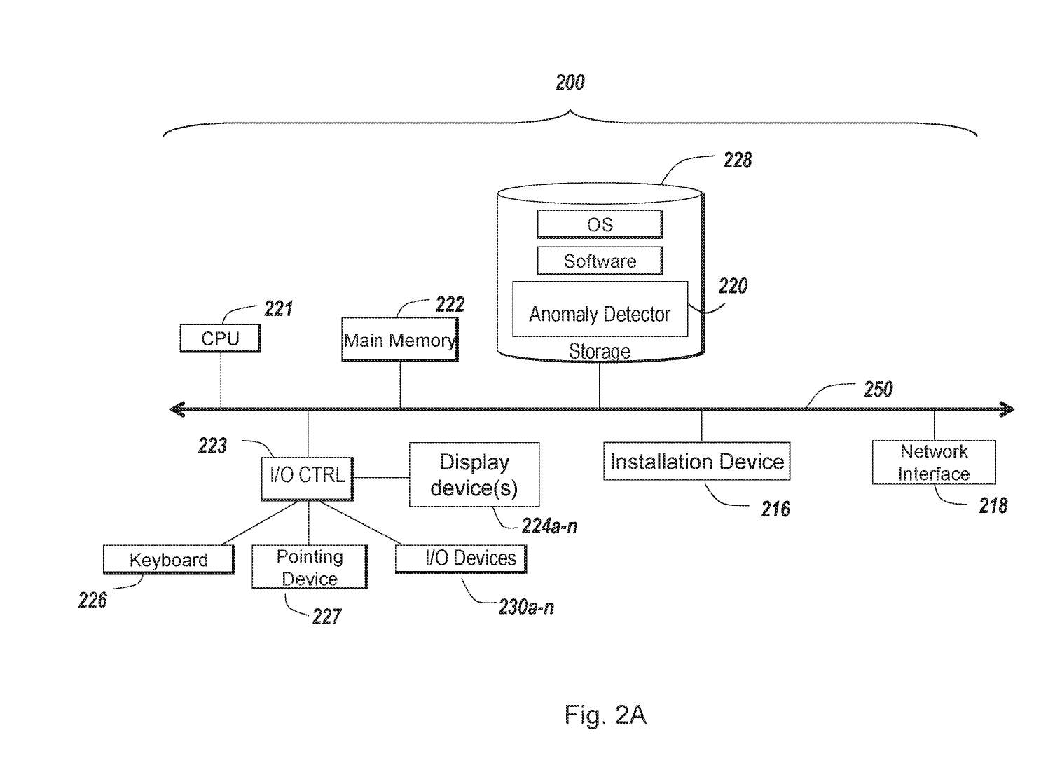

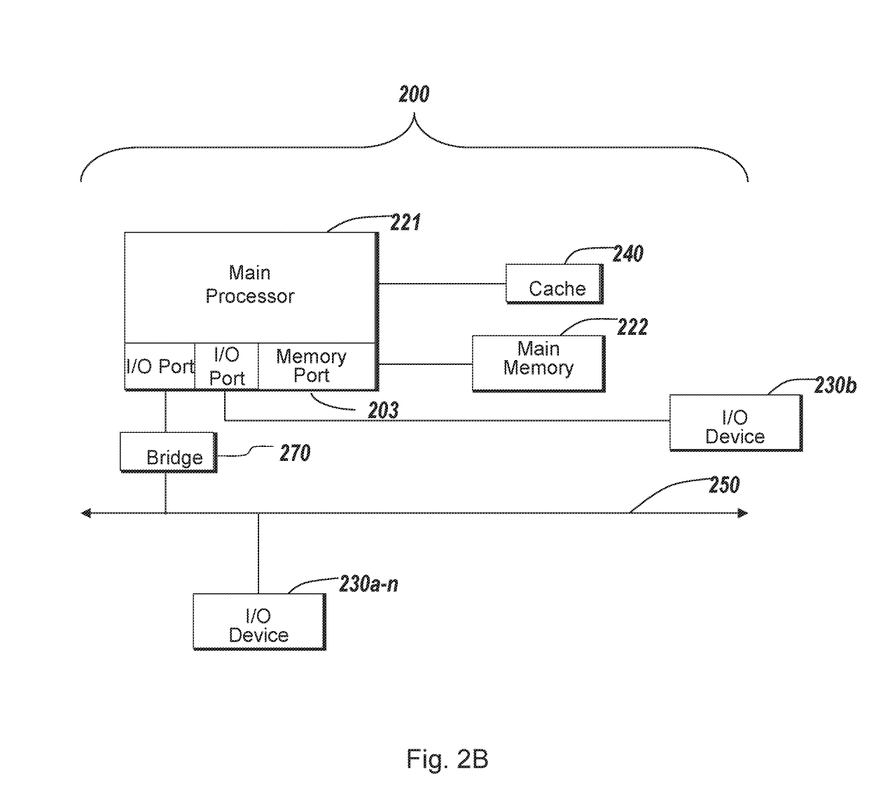

FIGS. 2A and 2B depict block diagrams of a computing device 200. As shown in FIGS. 2A and 2B, each computing device 200 includes a central processing unit 221, and a main memory unit 222. As shown in FIG. 2A, a computing device 200 may include a storage device 228, an installation device 216, a network interface 218, an I/O controller 221, display devices 224a-224n, a keyboard 226 and a pointing device 227, e.g. a mouse. The storage device 228 may include, without limitation, an operating system, software, and a software of a geographical ticker system (GTS) 220. As shown in FIG. 2B, each computing device 200 may also include additional optional elements, e.g. a memory port 203, a bridge 270, one or more input/output devices 230a-230n (generally referred to using reference numeral 230), and a cache memory 240 in communication with the central processing unit 221.

The central processing unit 221 is any logic circuitry that responds to and processes instructions fetched from the main memory unit 222. In many embodiments, the central processing unit 221 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 200 may be based on any of these processors, or any other processor capable of operating as described herein. The central processing unit 221 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 222 may include one or more memory chips capable of storing data and allowing any storage location to be directly accessed by the microprocessor 221. Main memory unit 222 may be volatile and faster than storage 228 memory. Main memory units 222 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 222 or the storage 228 may be non-volatile; e.g., non-volatile read access memory (NVRAM), flash memory non-volatile static RANI (nvSRAM), Ferroelectric RANI (FeRAM), Magnetoresistive RANI (MRAM), Phase-change memory (PRAM), conductive-bridging RAM (CBRANI), Silicon-Oxide-Nitride-Oxide-Silicon (SONOS), Resistive RAM (RRANI), Racetrack, Nano-RANI (NRAM), or Millipede memory. The main memory 222 may be based on any of the above described memory chips, or any other available memory chips capable of operating as described herein. In the embodiment shown in FIG. 2A, the processor 221 communicates with main memory 222 via a system bus 250 (described in more detail below). FIG. 2B depicts an embodiment of a computing device 200 in which the processor communicates directly with main memory 222 via a memory port 203. For example, in FIG. 2B the main memory 222 may be DRDRAM.

FIG. 2B depicts an embodiment in which the main processor 221 communicates directly with cache memory 240 via a secondary bus, sometimes referred to as a backside bus. In other embodiments, the main processor 221 communicates with cache memory 240 using the system bus 250. Cache memory 240 typically has a faster response time than main memory 222 and is typically provided by SRAM, BSRAM, or EDRAM. In the embodiment shown in FIG. 2B, the processor 221 communicates with various I/O devices 230 via a local system bus 250. Various buses may be used to connect the central processing unit 221 to any of the I/O devices 230, including a PCI bus, a PCI-X bus, or a PCI-Express bus, or a NuBus. For embodiments in which the I/O device is a video display 224, the processor 221 may use an Advanced Graphics Port (AGP) to communicate with the display 224 or the I/O controller 221 for the display 224. FIG. 2B depicts an embodiment of a computer 200 in which the main processor 221 communicates directly with I/O device 230b or other processors 221′ via HYPERTRANSPORT, RAPIDIO, or INFINIBAND communications technology. FIG. 2B also depicts an embodiment in which local busses and direct communication are mixed: the processor 221 communicates with I/O device 230a using a local interconnect bus while communicating with I/O device 230b directly.

A wide variety of I/O devices 230a-230n may be present in the computing device 200. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 230a-230n may include a combination of multiple input or output devices, including, e.g., Microsoft KINECT, Nintendo Wiimote for the WII, Nintendo WII U GAMEPAD, or Apple IPHONE. Some devices 230a-230n allow gesture recognition inputs through combining some of the inputs and outputs. Some devices 230a-230n provides for facial recognition which may be utilized as an input for different purposes including authentication and other commands. Some devices 230a-230n provides for voice recognition and inputs, including, e.g., Microsoft KINECT, SIRI for IPHONE by Apple, Google Now or Google Voice Search.

Additional devices 230a-230n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 230a-230n, display devices 224a-224n or group of devices may be augment reality devices. The I/O devices may be controlled by an I/O controller 221 as shown in FIG. 2A. The I/O controller may control one or more I/O devices, such as, e.g., a keyboard 126 and a pointing device 227, e.g., a mouse or optical pen. Furthermore, an I/O device may also provide storage and/or an installation medium 116 for the computing device 200. In still other embodiments, the computing device 200 may provide USB connections (not shown) to receive handheld USB storage devices. In further embodiments, an I/O device 230 may be a bridge between the system bus 250 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 224a-224n may be connected to I/O controller 221. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 224a-224n may also be a head-mounted display (HMD). In some embodiments, display devices 224a-224n or the corresponding I/O controllers 221 may be controlled through or have hardware support for OPENGL or DIRECTX API or other graphics libraries.

In some embodiments, the computing device 200 may include or connect to multiple display devices 224a-224n, which each may be of the same or different type and/or form. As such, any of the I/O devices 230a-230n and/or the I/O controller 221 may include any type and/or form of suitable hardware, software, or combination of hardware and software to support, enable or provide for the connection and use of multiple display devices 224a-224n by the computing device 200. For example, the computing device 200 may include any type and/or form of video adapter, video card, driver, and/or library to interface, communicate, connect or otherwise use the display devices 224a-224n. In one embodiment, a video adapter may include multiple connectors to interface to multiple display devices 224a-224n. In other embodiments, the computing device 200 may include multiple video adapters, with each video adapter connected to one or more of the display devices 224a-224n. In some embodiments, any portion of the operating system of the computing device 200 may be configured for using multiple displays 224a-224n. In other embodiments, one or more of the display devices 224a-224n may be provided by one or more other computing devices 200a or 200b connected to the computing device 200, via the network 104. In some embodiments software may be designed and constructed to use another computer's display device as a second display device 224a for the computing device 200. For example, in one embodiment, an Apple iPad may connect to a computing device 200 and use the display of the device 200 as an additional display screen that may be used as an extended desktop. One ordinarily skilled in the art will recognize and appreciate the various ways and embodiments that a computing device 200 may be configured to have multiple display devices 224a-224n.

Referring again to FIG. 2A, the computing device 200 may comprise a storage device 228 (e.g. one or more hard disk drives or redundant arrays of independent disks) for storing an operating system or other related software, and for storing application software programs such as any program related to the software 220 for the geographical ticker system. Examples of storage device 228 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 228 may be non-volatile, mutable, or read-only. Some storage device 228 may be internal and connect to the computing device 200 via a bus 250. Some storage device 228 may be external and connect to the computing device 200 via a I/O device 230 that provides an external bus. Some storage device 228 may connect to the computing device 200 via the network interface 218 over a network 104, including, e.g., the Remote Disk for MACBOOK AIR by Apple. Some client devices 200 may not require a non-volatile storage device 228 and may be thin clients or zero clients 202. Some storage device 228 may also be used as an installation device 216, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Computing device 200 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc.

Furthermore, the computing device 200 may include a network interface 218 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 200 communicates with other computing devices 200′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 200 to any type of network capable of communication and performing the operations described herein.

A computing device 200 of the sort depicted in FIG. 2A may operate under the control of an operating system, which controls scheduling of tasks and access to system resources. The computing device 200 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 200 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 200 has sufficient processor power and memory capacity to perform the operations described herein. In some embodiments, the computing device 200 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 200 is a gaming system. For example, the computer system 200 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 200 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 200 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 200 is a tablet e.g. the IPAD line of devices by Apple; GALAXY TAB family of devices by Samsung; or KINDLE FIRE, by Amazon.com, Inc. of Seattle, Wash. In other embodiments, the computing device 200 is an eBook reader, e.g. the KINDLE family of devices by Amazon.com, or NOOK family of devices by Barnes & Noble, Inc. of New York City, N.Y.

In some embodiments, the communications device 200 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 200 is a laptop or desktop computer equipped with a web browser and a microphone and speaker system, e.g. a telephony headset. In these embodiments, the communications devices 200 are web-enabled and can receive and initiate phone calls. In some embodiments, a laptop or desktop computer is also equipped with a webcam or other video capture device that enables video chat and video call.

In some embodiments, the status of one or more machines 200 in the network 104 are monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

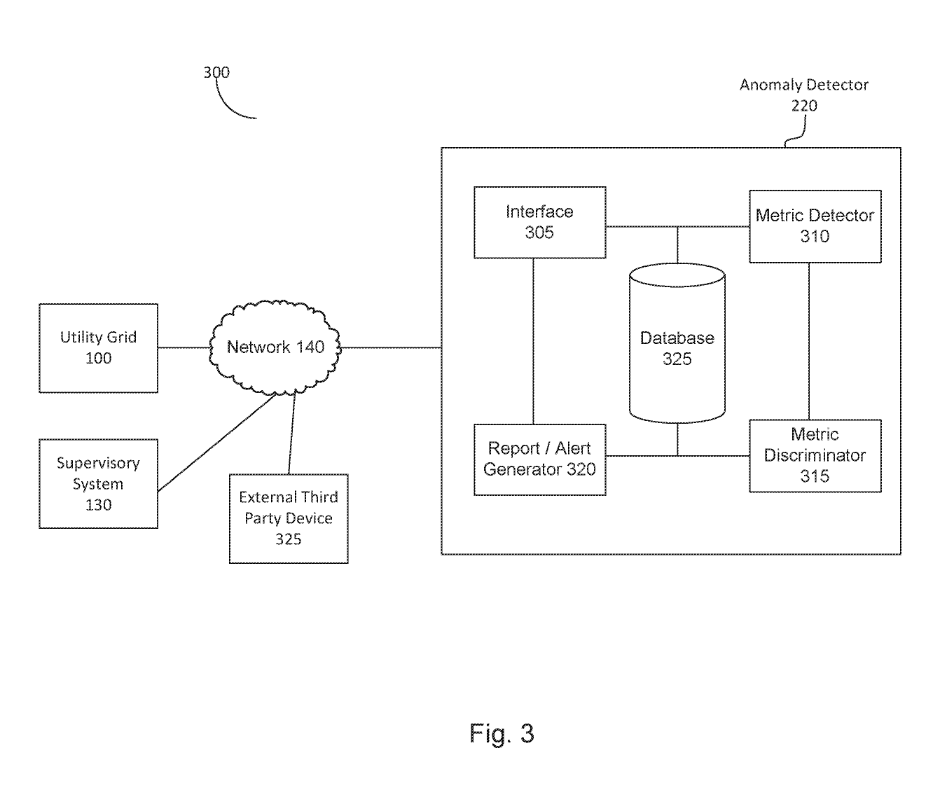

Referring now to FIG. 3, a system 300 for detecting anomalies in a utility grid 100 in accordance with an embodiment is shown. In brief overview, the system 300 includes an anomaly detector 220 designed and constructed to detect anomalies in a utility grid 100. The anomaly detector can detect intrusions in a utility network based on identifying anomalous interactions between utility control systems and relevant measures of the behavior of distribution grids. The anomaly detector 220 can include an interface 305 designed and constructed to interface with utility grid 100 via network 140 or other components or systems. The anomaly detector 220 can include a metric detector 310 that receives measurements from utility grid 100 (e.g., via metering devices 118a-n) and detects, identifies or computes one or more metrics. The anomaly detector 220 can include a metric discriminator 315 designed and constructed to quantitatively discriminate the metrics detected by metric detector 310. The anomaly detector 220 can include a report generator 320 or an alert generator 320 designed and constructed to generate a report based an anomaly identified via the anomaly detector 220. The alert generator 320 can provide the report to another system or device via interface 305, such as a supervisory system or operator of the utility grid 100. The anomaly detector 220 can include a database 325 that stores data structures in memory. The data structures can include measurements, metrics, samples, executable code, processes, reports, historical data, etc. The system 300 can include one or more component or functionality depicted in FIGS. 1, 2A and 2B. For example, the anomaly detector 220 can include one or more hardware component shown in FIGS. 2A and 2B, including, e.g., one or more processors and memory.

In further detail, the anomaly detector 220 includes an interface 305. The interface 305 can include one or more components of computing device 200 shown in FIGS. 2A and 2B. For example, the interface 305 can include input/output ports, communication ports, or a network interface. In some embodiments, the interface 305 can be configured to generate or provide a user interface that allows a user, operator or administrator of anomaly detector 220 to interact with the anomaly detector 220. The interface 305, via a graphical user interface, can receive input via buttons, input text boxes, pull-down menus, data files, batch upload processes, etc.

In some embodiments, the interface 305 is configured to receive meter observations from metering devices 118a-n. The interface 305 can continuously receive samples from metering devices 118a-n. The anomaly detector 220 can receive the meter observations in a batch upload process, e.g., hourly, every 12 hours, every 24 hours, weekly, monthly, or some other time interval. The meter observations can be indicative of a utility (e.g., energy, electricity, gas, water, data, bandwidth) delivered by a source (e.g., power source 101) to the plurality of consumer sites 119a-n via a distribution point 114. For example, the meter observations can include voltage or current information associated with energy delivered or consumed at a consumer site 119. The meter observations may be associated with a time indication (e.g., a time stamp) and information that identifies the metering device and/or consumer site. For example, one or more metering observation may include a time stamp and an identifier of the metering device or consumer site. The one or more metering observations may further include types of data such as voltage, current, energy, power, capacitance, inductance, resistance, or other characteristics of energy or a power distribution circuit. In some embodiments, the metering devices 118a-n may store the information or transmit the information to a computing device for further processing. In some embodiments, the metering devices transmit the information in real-time, such as a real-time data feed or streamlining. In some embodiments, the metering devices can periodically transmit the information to the computing device for further processing.

In some embodiments, the anomaly detector 220 includes a metric detector 310. The metric detector 310 can be configured with one or more methods or techniques to detect metrics indicative of a behavior of the utility grid 100, such as a nominal behavior of the utility grid 100. The metric detector 310 can establish the nominal behavior based on the behavior metrics that are known to contain no anomalies. For example, the metric detector 310 can identify behavior metrics or an estimation of behavior metrics that lack anomalies, or behavior metrics from which anomalies are absent. This nominal behavior can be referred to as a reference behavior, a baseline behavior, an expected behavior, a desired behavior, or an ideal behavior. The reference behavior can represent behavior of the utility grid in the absence of an attack or the absence of malware affecting a digital computation device to cause an anomaly in behavior. Thus, prior to the anomaly detector detecting an anomaly in monitored signals, the anomaly detector can establish behavior metrics that corresponds to a reference behavior or nominal behavior that does not contain an anomaly. For example, the metric detector 310 can establish a reference metric that is absent anomalies, and then establish a second metric based on current behavior of the system that may include an anomaly caused by an attack on a digital computation device of the utility grid 100.

The metric detector 310 can establish behavior metrics such as a consumption metric or a control metric that corresponds to or represents a nominal or reference behavior of the utility grid 100. The metric detector can generate the consumption metric using signals received from digital computation device of the utility grid, such as controllers of the utility grid or metering devices of the utility grid. The metric detector 310 can generate the control metric also using signals received from digital computation device of the utility grid, such as controllers of the utility grid or metering devices of the utility grid. The signals can include, for example, energy delivery process metrics such as primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites.

The primary level of the utility grid 100 can include digital computation devices or other components that are upstream of the secondary utilization circuit 116. For example, the primary level can include digital computation devices or components such as a distribution point 114, primary distribution circuit 112, voltage regulating transformer 106a, regulator interface 110, voltage controller 108, substation 104, power source 101, or substation transmission bus, primary regulator controls, primary capacitor controls, protective relays on the primary level or other meters on the primary level. A secondary level can include components or digital computation devices that are downstream of the primary distribution circuit or level, such as consumer sites 119a-n, potential transformers 120a-n, or metering devices 118a-n.

The metric detector 310 can establish the control metric or the consumption metric as representing nominal behavior of the utility grid. For example, the metric detector 310 can use statistical techniques to identify or determine a behavior of the utility grid 100. The metric detector 310 can employ techniques for stochastic processes (or random processes) that facilitate identifying the behavior of the utility grid 100 over time. The statistical techniques can include, e.g., a statistics of a random process or information content metrics for random processes. In some embodiments, the metric detector 310 can apply the statistics of a random process technique or the information content metrics for random processes technique to measure process interaction. By using statistical techniques configured for random processes, the metric detector 310 can model the progression of the utility grid 100 over time. Since observations close in time may be dependent, the metric detector 310 can model, simulate, or predict the behavior of the utility grid 100.

The metric detector 310 can apply these statistical techniques to one or more signals to determine a behavior or nominal behavior of the utility grid 100. The signals can include, e.g., primary voltages, one or more phases, obtained from metering devices 118a-n; secondary voltages, one or more phases, obtained from AMI system (e.g., for customer sites 119a-n); real energy and reactive ‘energy’ as metered on distribution circuit primary level 112; real energy and ‘reactive ‘energy’ where applicable on secondary distribution 116; temperature, humidity, cloud cover, and seasonal insolation for the affected area (e.g., obtained via network 140 from a weather repository, temperature sensors, humidity sensors, ambient temperature sensors, light sensors, barometers, etc.).

The metric detector 310 may then process the signals or apply an analysis technique to the signals to determine, identify, produce or generate one or more measures or metrics. The metric detector 310 can process the signals using a statistical analysis or technique. The statistical technique can include, e.g., auto-covariance of scalar stochastic time series (SSTS); covariance of a plurality of SSTS; auto- and cross-correlation of SSTS; entropy of SSTS as estimated from probability densities; coupled entropic measures of plural SSTS, such as the Kullback-Leibler Entropy (e.g., a non-symmetric measure of the difference between two probability distributions P and Q); or principal components analysis of hyper-dimensional signals resulting from matrix combinations of a plurality of signals recited above.

The metric detector 310 can determine the metric based on a model of the signals or model of the temporal behavior of the signals using one or more modeling techniques such as auto regressive (AR), moving average (MA), combined auto regressive moving average (ARMA), ARMA with assumed exogenous excitation components (ARMAX); or models of temporal behavior of signals that contemplate nonlinearity in the processes generating such signals, for example the nonlinear autoregressive moving average model or the exponential autoregressive model.

The metric detector 310 can determine the metric based on a model of an interaction between a control process and consumption using, for example, components of the Relative Gain Array as estimated for random signals (e.g., tool used to determine an optimal input-output variable pairings for a multi-input-multi-output (MIMO) system). In some cases, the metric detector 310 can model the interaction using a transfer function representing the system. The transfer function, or system function or network function, can include a representation of the relation between an input and output based on algorithms or models describing the system. For example, the transfer function can be based on linear or nonlinear control techniques. In a nonlinear control technique, the transfer function can be formed from nonlinear differential equations.

The metric detector 310 can form or define the transfer function using the consumption metric and the control metric or control process. The transfer function can include, for example, a transfer matrix. The metric detector 310 can configure the transfer function and provide the consumption metric as the input to the transfer function. The transfer function can output the control metric or control process. The metric detector 310 can model or quantify the behavior to identify a reference or nominal behavior by measuring the norms of the transfer function. The metric detector 310 can quantify the effect of the consumption input to the transfer function onto the control process output using an H₂ norm of the transfer matrix. A norm can refer to a function that assigns a length or size to each vector in a vector space. The norm can assign a positive length or size, or, in some cases, a length of zero. For example, the H₂ norm of the transfer function can be a measure of the energy content of the transfer function of the system, thus providing a metric that characterizes the transfer function. This metric can represent or indicate an interaction metric based on the consumption and control metric. The metric detector can determine that this interaction metric based on the H₂ norm of the transfer function represents a nominal or reference behavior between the interaction of consumption and a control process.

The metric detector 310 may store these established, determined or identified metrics, models, or measures in database 325 or one or more data structures in memory for further processing. The metric detector 310 can associate or assign an identifier to a behavior metric. The metric detector 310 can assign an identifier of a digital computation device or group of digital computation devices associated with the behavior metric. The metric detector 310 can assign, flag, or categorize the metric as a reference metric if the metric identifies nominal behavior of the utility grid 100 absent anomalies. The metric detector 310 may later retrieve the reference metric from the database to compare the reference metric with a metric generated from monitored signals that represents the current behavior of the utility grid 100. Establishing the reference metric can include determining and storing the metric identifying nominal behavior of the utility grid 100 absent anomalies. Establishing the reference metric can include retrieving the stored reference metric from the database 325. For example, the metric detector 325 can perform a lookup using an attribute in database 325 to identify the relevant reference metric. Attributes can include type of metric, consumption, control, interaction, technique used to generate the metric, time of day, geographic area, temperature, humidity, type of signals, type of devices, or subset of digital computation devices.

In some cases, the metric detector 310 can establish metrics for different digital computation devices. For example, the metric detector 310 can determine a first consumption metric for a first one or more metering devices 118a. The metric detector 310 can determine a second consumption metric for a second one or more metering devices 118n, where the second one or more metering devices is different from the first one or more metering devices. The metric detector 310 can similarly determine different control metrics for different digital computation devices, such as different controllers 108 or voltage controllers 108.

The metric detector 310 can monitor signals received from the digital computing devices, or signals observed by the digital computation devices. The metric detector 310 can monitor signals from digital computing devices for which a nominal behavior metric has been determined. In some cases, the metric detector 310 an continuously monitor signals, periodically receive signals based on a time interval, request signals from certain digital computation devices, or fetch or retrieve signals stored at an intermediary system such as a supervisory system 130. In some cases, the supervisory system 130 can push signals to the anomaly detector 220. In some cases, the anomaly detector includes the supervisory system 130.

The metric detector 310 can establish, determine or identify metrics for a geographic area using at least one of temperature information, humidity information, cloud cover information, or seasonal insolation. Solar insolation can refer to solar irradiance for a season (e.g., winter, spring, summer, fall) for a geographic area. Solar irradiance can refer to the power per unit area produced by the Sun in the form of electromagnetic radiation. Irradiance may be measured in space or at the Earth's surface after atmospheric absorption and scattering. Irradiance can be measured in watt per square meter. Cloud cover can refer to the fraction of the sky that is obscured by clouds when observed from a particular location or geographic area. Cloud cover can be measured in Okta.

The metric detector 310 can obtain temperature information, humidity information, cloud cover information or seasonal insolation from a data repository or database accessible via network 140, such as a weather database maintained at a weather data center. The metric detector 310 can include one or more sensors configured to sense or measure temperature, humidity, cloud cover, or seasonal insolation. In some cases, the metric detector 310 can receive the temperature, humidity, cloud cover or seasonal insolation information via one or more digital computation devices. For example, this information can be included in or along with signals received from the digital computation devices. The metric detector 310 can then monitor the signals for the same geographic area for comparison to detect the anomaly.

The metric detector 310 can continuously monitor signals received from or via one or more digital computation devices, such as controllers or metering devices of the utility grid. The metric detector 310 can monitor signals based on a predetermined time interval (e.g., every 1 minute, 2 minutes, 5 minutes, 10 minutes, 30 minutes, 1 hour, 6 hours, 12 hours, etc.). The metric detector 310 can monitor signals in real-time (e.g., as digital computation devices determine or measure characteristics of or related to the utility grid and generate and provide a signal corresponding to the measured or determined characteristics). The monitor signals can indicate current or substantially current (e.g., within 5 minutes, within 10 minutes, within 30 minutes, 3 hours, within 6 hours, within 12 hours, within 24 hours, within 48 hours, or within 72 hours) behavior of the utility grid 100.

In some embodiments, the anomaly detector 220 includes a metric discriminator 315 designed and constructed to quantitatively discriminate the metrics produced by metric detector 310. The metric discriminator can retrieve the measures or metrics produced, established or generated by the metric detector 310 from the database 325, or directly from metric detector 310. The metric discriminator 315 can quantitatively discriminate the metrics such that deviations from expected process behavior may be identified. The metric discriminator 315 can compare the established metrics representing nominal behavior with monitored signals received via the one or more digital computation devices to detect an anomaly. This anomaly can be attributable to an attack on at least one of a controller of the one or more controllers or a metering device of the one or more metering devices.

In some cases, the metric discriminator 315 can compare a first metric with a second metric to detect an anomaly. The first metric can include a reference metric that identifies nominal behavior of the utility grid 100 absent anomalies. The reference metric can be retrieved from database 325. The second metric can include a current or real-time metric that indicates a current or substantially current behavior of the utility grid 100 determined using monitored signals. In some cases, the metric detector 310 can monitor signals, determine that a statistically significant number of signals are present to generate a metric using the monitored signals, generate the metric, and then instruct the metric discriminator 315 to discriminate the generated metric. The metric discriminator 315, responsive to receiving the metric generated using monitored signals of the utility grid 100, can discriminate the metric. The generated metric can be a same type of metric as the reference metric retrieved from the database 325.

In some cases, the first metric or reference metric can include a consumption metric, a control metric, or both the consumption metric and the control metric. The metric discriminator 315 can compare the reference metric with the metric generated using the monitored signals to detect an anomaly in a control process, an anomaly in consumption, or an anomaly in an interaction between a control process of the one or more controllers and consumption observed via the one or more metering devices. In some cases, the metric discriminator 315 can compare the consumption metric with the monitored signals to detect an anomaly in consumption observed via the one or more metering devices, where the anomaly is attributable to an attack on a metering device of the utility grid 100. In some cases, the metric discriminator 315 can compare the control metric with the monitored signals to detect an anomaly in a control process of the one or more controllers, where the anomaly is attributable to an attack on a controller of the utility grid 100.

For example, the metric discriminator 315 can determine a reference metric that does not contain an anomaly, and a metric based on monitored signals. The monitored signals can be signals received in real-time, or signals received over a time interval such as the last 2 minutes, 5 minutes, 10 minutes, 20 minutes, 1 hour, 6 hours, 12 hours, etc. The anomaly detector can then compare the reference metric with the metric based on monitored signals to detect the anomaly. The reference metric and the metric based on monitored signals may be the same type of metric (e.g., a metric based on voltage, or demand) to facilitate comparison. The anomaly can be attributable to an attack on a digital computation device of the utility grid, such as a controller or a metering device.

To detect the anomaly, the metric discriminator 315 can determine behavior metrics based on the monitored signals, and compare these behavior metrics of the monitored signals with the corresponding established reference or nominal metrics that do not contain anomalies. The metric discriminator 315 can be configured with one or more techniques to perform the comparison or discrimination to identify the anomaly. The techniques may include, e.g., vector threshold testing (e.g., to identify a value above a threshold); linear discriminant analysis (e.g., a linear combination of features which characterizes or separates two or more classes of objects or events); or pattern identification and classification (e.g., using neural network methods); symbolic regression of the expression spaces of the detection metrics; or regression methods applied to the parameters of the behavior detection metrics for identification of the most significant parameters, including such methods as conventional parsimony evaluation of regression coefficients.

In an illustrative example, the anomaly detector 220 may obtain a first set of metered observations. The anomaly detector 220 may detect that for this first set of metered observations, when the temperature increased above a threshold temperature during the day, electricity consumption increased, which caused the voltage controller 108 to increase a tap setting 106b of the voltage regulating transformer 106a. The anomaly detector 220 may determine that this behavior, e.g., temperature increasing during the day causing increased tap settings may be the normal behavior. However, during a second set of metered observations, the anomaly detector 220 may identify a similar temperature during the day, and an increase in electricity demand, however the voltage controller 108 may not adjust the tap setting 106b in a similar manner. Instead, the voltage controller 108 may lower the tap setting 106b instead of increasing it. Thus, the anomaly detector 220 may detect this anomaly based on a variance from a normal behavior. The anomaly detector 220 may identify this anomaly and may further determine that it is due to a malicious code or attack on a component in the utility grid (e.g., the voltage controller 108 or false reading from metering device 118a-n or other device in the utility grid).

The attack can include a cyber-attack, digital attack, electronic attack, physical attack or other attack that can affect a digital computation device to cause an anomaly in a utility grid behavior, such as consumption or control process. In some cases, the malware can be installed on a device internal to the utility grid 100, an external device 325 or an external third party device 325 that can attack the controller or the metering device via a network to cause the anomaly. The attack can include malicious software (or malware) installed on a digital computation device, such as a controller or a metering device. The malware can be configured to cause the anomaly by manipulating an operation of the digital computation device, manipulating data received or provided by the digital computation device, disabling the digital computation device, or adjusting an operation parameter or threshold of the digital computation device. Malware can include viruses, hijacking software, bots, rootkit, worms, etc.

In some cases, the attack can include a physical attack where a digital computing device is physically manipulated, tampered with, or otherwise adjusted to cause an anomaly. For example, a sensor of a metering device can be blocked or prevented from accurately observing a characteristic of electricity or the environment such as voltage, temperature, or humidity. Thus, the metering device may report that the voltage has remained constant, even though the voltage controller has instructed the regulator to increase the output voltage level. In some cases, the attack can be caused by equipment malfunction due to, for example, partial failure of a digital computation device resulting in an unexpected operational characteristic.

The external third party device 325 can be external to utility grid 100. The external device 325 can be external because it may not be originally designed to be part of the utility grid 100 by a utility grid operator. The external device 325 can include a computer, desktop computer, laptop, server or other computation device. The external third party device 325 can include one or more component of system 200 or system 100. For example, the external third party device 325 can include an interface designed and constructed to interface with one or more component or digital computation device of utility grid 100. The third party device 325 can interface with a digital computation device of the utility grid 100 via network 140 such as the Internet or an Intranet. The third party device 325 may directly interact or attack the digital computation without using the internet. For example, the third party device 325 may be connected to a digital computation device via a direct wired or wireless connection (e.g., ZigBee, Bluetooth, or Near Field Communication). The third party device 325 may attack or manipulate the digital computation device by sending fake commands, instructions, measurements, readings, etc. Third party may refer to an unauthorized actor or other entity that intends to attack the utility grid 100 or component thereof to cause the anomaly.

In some embodiments, the anomaly detector 220 includes an alert generator 320 or report generator 320 designed and constructed to generate a report based on the detected anomalies. The report may identify anomalous or otherwise unexpected process behaviors, including measures and confidence of detection and likelihood of the presence of a malicious actor. The alert generator 320 can report this information to a supervisory system or other administer or operator of the utility grid or anomaly detector. The reports of such identified behaviors may include search advisory information useful to digital network traffic analysis systems. This information can be developed by analyzing the network connectivity of affected assets.

In some embodiments, the anomaly detector 220 can identify the digital computation device affected by an attack that caused the anomaly, and provide the identification of the affect digital computation device in the search advisory information. The anomaly detector 220, via metric detector 310 and metric discriminator 315, can identify the origin of the signals under consideration (e.g., identify the digital computation device that provided a signal associated with an anomaly). For example, each signal can include or be an associated with an identifier of the digital computation device corresponding to the signal. The identifier can identify the digital computation device that observed the signal, measured the signal, monitored the signal, generated the signal, or sent the signal. In some cases, the identifier can include multiple identifiers in which the signal is routed among multiple digital computation devices (e.g., via a mesh network). The identifier can also identify a location of the digital computation device, such as geographic coordinates (latitude, longitude), an address or other geographic marker.

Thus, the anomaly detector 220 can, responsive to monitoring signals received from digital computation devices and discriminating the signals to detect an anomaly, identify the one or more digital computation devices corresponding to the one or more signal that triggered the detection of the anomaly. The anomaly detector 220 can, therefore, trace the anomalous to a digital computation device or other measuring instrument of the utility grid 100. The report generator 320 can provide an alert, report, indication or aspect thereof via push notifications, alerts, SMS messages, electronic mail, alarm, light, acoustic alarm, etc.

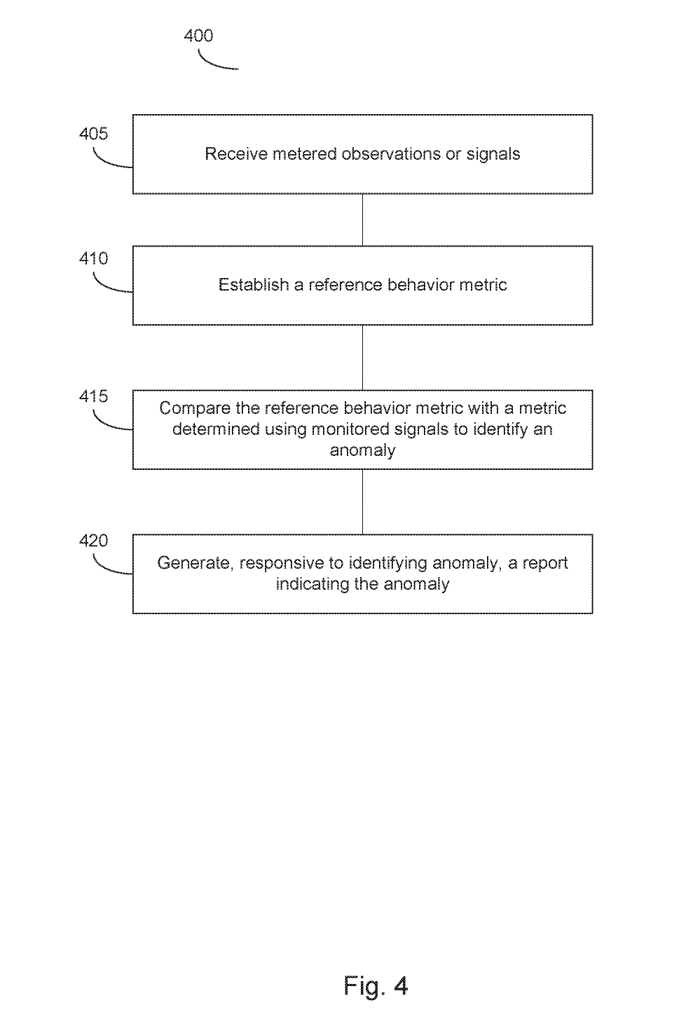

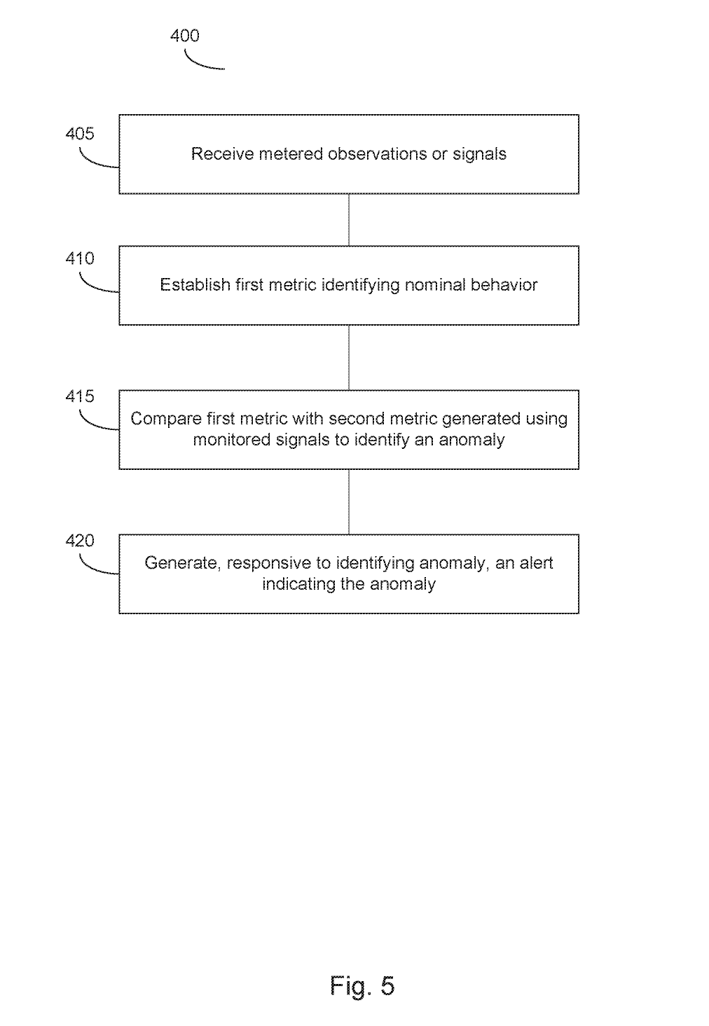

FIGS. 4 and 5 are flow charts depicting a method 400 for detecting anomalies in a utility grid in accordance with an embodiment. The method 400 can be performed by one or more component or system depicted in FIGS. 1, 2A, 2B and 3. For example, the method 400 can be performed by anomaly detector 220. The method 400 can detect intrusions in utility network based on identifying anomalous interactions between utility control systems and relevant measures of the behavior of distribution grids. In brief overview, at step 405, an anomaly detector receives metered observations. At step 410, the anomaly detector establish a reference behavior metric that identifies nominal behavior of the utility grid absent anomalies. At step 415, the anomaly detector can compare the reference behavior metric with a metric determined using monitored signals to identify an anomaly. At step 420, the anomaly detector can generate, responsive to identify the anomaly, a report or alert indicating the anomaly.

The anomaly detector can establish a reference metric identifying nominal behavior of the utility grid absent anomalies. In some cases, the anomaly detector may retrieve the reference metric from a database storing reference metrics. In some cases, the anomaly detector can monitor signals from digital computation devices of the utility grid, process the signals to generate the metric, and then store the metric as a reference metric in the database. The anomaly detector can store the metric as a reference metric if the metric identifies nominal or expected behavior. For example, the metric may indicate that on a hot day with increased electricity consumption due to air conditioning, a voltage controller increases an output voltage level, metering devices at the primary level indicate a higher voltage level, and metering devices at a consumer site indicate increase power consumption. In another example, as the temperature decreases and the time of day approaches midnight, metering devices can indicate decreases consumption, and the voltage controller can, responsive to receiving signals indicating decreased consumption, lower the output voltage level.

At step 405, the anomaly detector receives signals including metered observations or control information. The metered observations can be received from one or more metering devices of a utility grid. The metered observations can include information about a utility that is delivered, produced, consumed, or otherwise used. The information can include, e.g., characteristics of the utility. For example, in an electrical grid, metered observations can include characteristics of electricity that is consumed or provided such as voltage, current, power, resistance, reactance, capacitance, inductance, real power. The characteristics of electricity may further refer to or correspond to points in the utility grid. For example, a real energy and reactive energy as metered on a distribution circuit at the primary level, or a real energy and reactive energy measured at the secondary distribution circuit.

Signals or metered observation information may further include information about the environment such as temperature, ambient temperature, average temperature, high/low temperature for a time interval, humidity, pressure, cloud cover, rain, precipitation, or season insolation for an area. In some embodiments, the anomaly detector can receive signals corresponding to energy delivery process metrics. These signals can include primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites. The signals can include or be associated with identification information that identifies a digital computation device of the utility grid 100 that observed, measured or otherwise provided the signal.

The signals may correspond to a time series of measurements taken at a circuit in a distribution grid that is energized by at least one substation. The signals can include one or more of the following: primary voltages, one or more phases, obtained from metering devices; secondary voltages, one or more phases, obtained from an advanced metering infrastructure (AMI) system; real energy and reactive energy as metered on the distribution circuit primary level; power or demand determined as the first time derivative of energy; real energy and reactive energy where applicable on secondary distribution; or temperature, humidity, cloud cover, or seasonal insolation for the affected area. In some cases, signals may include or refer to changes in supplied voltage (e.g., via adjusting tap settings) or changes in consumption.

At step 410, the anomaly detector can establish, identify, generate or detect behavior metrics using the received signals. The anomaly detector can establish a reference metric indicating nominal behavior of the utility grid absence anomalies. In some cases, establishing the reference metric can include retrieving a metric from a database storing a predetermined reference metric. If the database does not include a reference metric, or the reference metric is not relevant or otherwise invalid (e.g., outdated, expired, a different type of metric), the anomaly detector can generate the reference metric using monitored signals. The reference metric can include a control metric or a consumption metric.

The signals may include metered observation information or control information. The anomaly detector can establish a nominal or reference behavior for the utility grid. The anomaly detector can, for example, establish or identify the reference behavior as the behavior metrics corresponding to an absence of an anomaly. The absence of an anomaly can indicate an expected, desired, planned, predicted, or ideal behavior of the utility grid. The absence of an anomaly can indicate an behavior of the utility grid in the absence of an attack. The reference behavior can represent behavior of the utility grid in the absence of an attack or the absence of malware affecting a digital computation device to cause an anomaly in behavior. The anomaly detector can apply techniques based on stochastic processes to identify the behavior. The anomaly detector can determine a consumption metric or a control metric using signals received from one or more controllers of the utility grid or one or more metering devices of the utility grid. The anomaly detector can further establish the control metric and the consumption metric as identifying nominal behavior of the utility grid. For example, the anomaly detector, supervisory system, or operator thereof can determine that the control metric and consumption metric corresponds to nominal or expected behavior for a certain location, season, temperature, humidity, or insolation. The anomaly detector can detect intrusions in utility network based on identifying anomalous control signals, consumption signals, or interactions between utility control systems and consumption as indicated by relevant measures of the behavior of distribution grids.

For example, the anomaly detector can process or analyze one or more of these signals to produce behavior detection metrics, including control metrics and consumption metrics. The anomaly detector can process the signals using, for example, auto-covariance of scalar stochastic time series (SSTS); covariance of a plurality of SSTS; auto- and cross-correlation of SSTS; entropy of SSTS as estimated from probability densities; models of temporal behavior of signals, such as auto regressive (AR), moving average (MA), combined auto regressive moving average (ARMA), ARMA with assumed exogenous excitation components (ARMAX); models of temporal behavior of signals that contemplate nonlinearity in the processes generating such signals, such as the nonlinear autoregressive moving average models or the exponential autoregressive models; coupled entropic measures of plural SSTS, such as the Kullback-Leibler Entropy; principal components analysis of hyper-dimensional signals resulting from matrix combinations of a plurality of signals recited above; or components of the Relative Gain Array as estimated for random signals.

At step 415, the anomaly detector can discriminate behavior metrics to identify an anomaly. The anomaly detector can compare the reference metric (e.g., the consumption metric or the control metric) with a current or real-time metric generated using monitored signals to detect an anomaly in a control process, an anomaly in consumption, or an anomaly in an interaction between a control process and consumption. The anomaly detector can compare the consumption metric or the control metric with metrics based on the monitored signals to detect an anomaly. For example, the anomaly detector can determine a first metric or reference that does not contain an anomaly, and a second metric based on monitored signals. The anomaly detector can then compare the reference metric with the second metric represent current behavior of the utility grid based on monitored signals to detect the anomaly. The reference metric and the second metric may be the same type of metric (e.g., a metric based on voltage, or demand) to facilitate comparison. The anomaly detector can generate or determine the second metric using the same or similar techniques used to generate or determine the reference metric. The anomaly can be attributable to an attack on a digital computation device of the utility grid, such as a controller or a metering device.

To detect the anomaly, the anomaly detector can quantitatively discriminate the behavior detection metrics indicating nominal behavior with monitored signals to identify deviations from the expected or nominal process behavior. For example, the system can be configured to use one or more of the following techniques to quantitatively discriminate the behavior detection metrics: simple vector threshold testing; linear discriminant analysis; or pattern identification and classification (e.g., using neural network methods); or symbolic regression of the expression spaces of the detection metrics; or regression methods applied to the parameters of the behavior detection metrics for identification of the most significant parameters, including such methods as conventional parsimony evaluation of regression coefficients.

In some cases, the anomaly detector can compare a reference consumption metric with a current consumption metric to detect an anomaly. The anomaly detector can further trace the signals used to generate the current consumption metric to identify a metering device that provided the signals. For example, the current consumption metric can be generated using signals from a particular metering device. The anomaly detector can then provide an alert identifying the metering device as being affected by an attack that caused the anomaly.

In some cases, the anomaly detector can compare a reference control metric with a current control metric to detect an anomaly. The anomaly detector can further trace the signals used to generate the current control metric to identify a controller that provided the signals. For example, the current control metric can be generated using signals from a particular controller. The anomaly detector can then provide an alert identifying the controller as being affected by an attack that caused the anomaly.

At step 420, the anomaly detector can generate a report indicative of the identified anomaly. In some embodiments, the anomaly detector can generate a report that indicates that there is no anomaly. In some embodiments, the report may indicate a component or asset affected with malicious code. The report may include an identifier of the distribution grid, consumer site, substation, primary distribution circuit, distribution point, secondary utilization circuit, voltage controller, or other component or asset that may or may not be affected by a network intrusion. The anomaly detector can provide the report to a supervisory system that is configured to control, monitor, supervise, or otherwise manage the utility grid.

In some embodiments, the anomaly detector can generate an alert that includes a command or instruction to adjust an operating parameter of a digital computation device. For example, the anomaly detector can, responsive to detecting an anomaly, reset a metering device or controller to a predetermined state or configuration, provide a software patch to the controller or metering device, or disable the controller or metering device.

In some cases, the anomaly detector can repeatedly generate a metric using monitored signals indicating current behavior, and compare or discriminate this metric with a reference metric to detect an anomaly. For example, once the reference metric has been established, the anomaly detector can automatically and continuously determine a current metric and compare the current metric with the reference metric. The anomaly detector can generate and discriminate the current metric based on a time interval (e.g., every 1 minute, 5 minutes, 10 minutes, 30 minutes, 1 hour). The anomaly detector can generate and discriminate the current metric responsive to an event, condition or trigger. For example, the anomaly detector can generate and discriminate the current metric responsive to obtaining sufficient signals with which to generate a metric, responsive to receiving an alert from a metering device, or responsive to a request to perform the comparison.

In some embodiments, the anomaly detector can detect the anomaly responsive to the comparison. The anomaly detector can detect the anomaly if the reference metric and the current metric are not identical or differ by more than a threshold (e.g., 1%, 5%, 10%, 15% 25%, or 50%). In some embodiments, the anomaly detector can detect the anomaly if a control process was anomalous; e.g., a voltage controller should have increased output voltage level based on increased consumption, but, instead, the voltage controller did not change the output voltage or decreased the voltage output level. In another example, an anomaly could refer to the metering device not indicating an increase in voltage level on the primary, even though the voltage controller increased the output voltage. In another example, an anomaly could refer to an outdoor metering device indicating an ambient temperature of 35 degrees Celsius when the season is winter and the forecasted temperature is 0 degrees Celsius.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “computation device” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, both special purpose microprocessors. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Although an example computing system has been described in FIG. 2A-2B, embodiments of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

While this specification contains many specific implementation details, these should not be construed as limitations on the scope of any subject matter or of what may be claimed, but rather as descriptions of features specific to particular embodiments. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the subject matter have been described. Other embodiments are within the scope of the following claims. While operations are depicted in the drawings in a particular order, this should not be understood as requiring that such operations be performed in the particular order shown or in sequential order, or that all illustrated operations are required to be performed. Actions described herein can be performed in a different order. In addition, the processes depicted in the accompanying figures do not necessarily require the particular order shown, or sequential order, to achieve desirable results. In certain embodiments, multitasking and parallel processing may be advantageous.

The separation of various system components does not require separation in all embodiments, and the described program components can be included in a single hardware or software product. For example, the metric detector 310 and the metric discriminator 315 can be a single module, a logic device having one or more processing circuits, or part of an online content item placement system.

Having now described some illustrative embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one embodiment are not intended to be excluded from a similar role in other embodiments.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any embodiment disclosed herein may be combined with any other embodiment or embodiment, and references to “an embodiment,” “some embodiments,” “an alternate embodiment,” “various embodiment,” “one embodiment” or the like are not necessarily mutually exclusive and are intended to indicate that a particular feature, structure, or characteristic described in connection with the embodiment may be included in at least one embodiment or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method of detecting an attack in a utility grid, comprising:
establishing, by an anomaly detector executing on one or more processors, a first metric using signals received from at least one of one or more controllers of the utility grid or one or more metering devices of the utility grid, the first metric identifying nominal behavior of at least one of control or consumption in the utility grid absent anomalies;
monitoring, by the anomaly detector, signals received from at least one of the one or more controllers or the one or more metering devices;
determining, by the anomaly detector, using the monitored signals a second metric identifying current behavior of at least one of control or consumption in the utility grid;
comparing, by the anomaly detector, the first metric with the second metric to detect an anomaly in at least one of control or consumption in the utility grid, wherein the anomaly is attributable to an attack on at least one of a controller of the one or more controllers or a metering device of the one or more metering devices; and
providing, by the anomaly detector, an alert indicating the detected anomaly.

2. The method of claim 1, comprising:
establishing, by the anomaly detector, the first metric as a first consumption metric and a first control metric;
establishing, by the anomaly detector, the second metric as a second consumption metric and a second control metric;
comparing, by the anomaly detector, the first metric with the second metric to detect the anomaly in an interaction between a control process of the one or more controllers and consumption observed via the one or more metering devices.

3. The method of claim 1, comprising:
establishing, by the anomaly detector, the first metric as a first consumption metric;
establishing, by the anomaly detector, the second metric as a second consumption metric;
comparing, by the anomaly detector, the first consumption metric with the second consumption metric to detect the anomaly in consumption observed via the one or more metering devices, wherein the anomaly is attributable to the attack on the metering device of the one or more metering devices; and
providing, by the anomaly detector, the alert indicating the detected anomaly and identifying the metering device affected by the attack that causes the anomaly.

4. The method of claim 1, comprising:
establishing, by the anomaly detector, the first metric as a first control metric;
establishing, by the anomaly detector, the second metric as a second control metric;
comparing, by the anomaly detector, the first control metric with the second control metric to detect the anomaly in a control process of the one or more controllers, wherein the anomaly is attributable to an attack on the controller of the one or more controllers; and
providing, by the anomaly detector, the alert indicating the detected anomaly and identifying the controller affected by the attack that causes the anomaly.

5. The method of claim 1, wherein the attack comprises at least one of malware installed on the controller or the metering device configured to cause the anomaly, or malware installed on a third party device configured to attack the controller or the metering device via a network to cause the anomaly.

6. The method of claim 1, comprising:
determining, by the anomaly detector, the first metric and the second metric based on one or more energy delivery process metrics comprising at least one of primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites.

7. The method of claim 1, comprising:
establishing, by the anomaly detector, the first metric and the second metric based on at least one of a covariance of a scalar stochastic time series, correlation of a scalar stochastic time series, entropy of a scalar stochastic time series, or a transfer function of a system representing the utility grid.

8. The method of claim 1, comprising:
comparing, by the anomaly detector, the first metric with the second metric to detect the anomaly using at least one of a vector threshold, a linear discriminant technique, or a neural network.

9. The method of claim 1, comprising:
providing, by the anomaly detector via a network, the alert to a supervisory system of the utility grid, the alert configured to cause the supervisory system to adjust an operation parameter of the controller or the metering device.

10. The method of claim 1, comprising:
generating, by the anomaly detector, the first metric for a geographic area using at least one of temperature information, humidity information, cloud cover information, or seasonal insolation; and
generating, by the anomaly detector, the second metric for the same geographic area to detect the anomaly.

11. A system to detect an attack in a utility grid, comprising:
a metric detector executed by one or more processors configured to establish a first metric using signals received from at least one of one or more controllers of the utility grid or one or more metering devices of the utility grid, the first metric identifying nominal behavior of at least one of control or consumption in the utility grid absent anomalies;
the metric detector further configured to monitor signals received from at least one of the one or more controllers or the one or more metering devices;
the metric detector further configured to determine using the monitored signals a second metric identifying current behavior of at least one of control or consumption in the utility grid;
a metric discriminator executed by the one or more processors configured to compare the first metric with the second metric to detect an anomaly, wherein the anomaly is attributable to an attack on at least one of a controller of the one or more controllers or a metering device of the one or more metering devices; and
an alert generator executed by the one or more processors configured to provide the alert indicating the detected anomaly.

12. The system of claim 11, comprising:
the metric detector further configured to establish the first metric as a first consumption metric and a first control metric;
the metric detector further configured to establish the second metric as a second consumption metric and a second control metric;
the metric discriminator further configured to compare the first metric with the second metric to detect the anomaly in an interaction between a control process of the one or more controllers and consumption observed via the one or more metering devices.

13. The system of claim 11, comprising:
the metric detector further configured to establish the first metric as a first consumption metric;
the metric detector further configured to establish the second metric as a second consumption metric;
the metric discriminator further configured to compare the first consumption metric with the second consumption metric to detect the anomaly in consumption observed via the one or more metering devices, wherein the anomaly is attributable to the attack on the metering device of the one or more metering devices; and
the alert generator further configured to provide the alert indicating the detected anomaly and identifying the metering device affected by the attack that causes the anomaly.

14. The system of claim 11, comprising:
the metric detector further configured to establish the first metric as a first control metric;
the metric detector further configured to establish the second metric as a second control metric;
the metric discriminator further configured to compare the first control metric with the second control metric to detect the anomaly in a control process of the one or more controllers, wherein the anomaly is attributable to an attack on the controller of the one or more controllers; and
the alert generator further configured to provide the alert indicating the detected anomaly and identifying the controller affected by the attack that causes the anomaly.

15. The system of claim 11, wherein the attack comprises at least one of malware installed on the controller or the metering device configured to cause the anomaly, or malware installed on a third party device configured to attack the controller or the metering device via a network to cause the anomaly.

16. The system of claim 11, comprising:
the metric detector further configured to determine the first metric and the second metric based on one or more energy delivery process metrics comprising at least one of primary voltage information received via the one or more metering devices, secondary voltage information received via an advanced metering infrastructure (AMI) system, real energy or reactive energy observed at one or more devices located on a primary level of the utility grid, or voltage information observed at one or more delivery sites.

17. The system of claim 11, comprising:
the metric detector further configured to establish the first metric and the second metric based on at least one of a covariance of a scalar stochastic time series, correlation of a scalar stochastic time series, entropy of a scalar stochastic time series, or a transfer function of a system representing the utility grid.

18. The system of claim 11, comprising:
the metric discriminator further configured to compare the first metric with the second metric to detect the anomaly using at least one of a vector threshold, a linear discriminant technique, or a neural network.

19. The system of claim 11, comprising:
the alert generator further configured to provide, via a network, the alert to a supervisory system of the utility grid, the alert configured to cause the supervisory system to adjust an operation parameter of the controller or the metering device.

20. The system of claim 11, comprising:
the metric detector further configured to generate the first metric for a geographic area using at least one of temperature information, humidity information, cloud cover information, or seasonal insolation; and
the metric detector further configured to generate the second metric for the same geographic area to detect the anomaly.
